(19) United States
(12) Patent Application Publication
(10) Pub. No.: US 2022/0332465 A1
(43) Pub. Date: Oct. 20, 2022

(54) Resizable Food Storage Container

(71) Applicant: Carlos Garcia, Leavenworth, WA (US)

(72) Inventor: Carlos Garcia, Leavenworth, WA (US)

(21) Appl. No.: 17/234,729

(22) Filed: Apr. 19, 2021

(51) Int. Cl. B65D 21/08; B65D 43/02; A47J 47/08

(52) U.S. Cl. CPC B65D 21/083; B65D 43/02; A47J 47/08

(57) ABSTRACT

An article of manufacture for providing a resizable food storage container in different configurations is disclosed. The resizable food storage container includes a container surface wall, a removable lid, and a movable bottom element configured to change a position within the container surface wall changing the storage volume depending upon the position of the movable bottom element within the container surface wall. The movable bottom element has an inner bottom surface, an outer bottom surface, and a gasket material coupled to a sealing surface between the inner bottom surface and the outer bottom surface, the gasket material extends outward from the inner bottom surface to fill any gap to the container surface wall. The resizable storage container may be made of plastic, low-density polyethylene (LPDE), polypropylene (PP), polyethylene (PE), liquid crystal polymer (LCP), polyether sulfone (PES), rubber, glass, and waxed paper and cardboard, and similar food container materials.

### TECHNICAL FIELD

This application relates in general to an article of manufacture for providing food storage, and more specifically, to an article of manufacture for providing a resizable food storage container.

### BACKGROUND

Existing food storage containers on the market have a fixed volume. Therefore, unless you use the entire contents of the container when removing food, you will have air space left in the container after removing just a portion of the food in the container. There are containers on the market that allow you to push a button on the lid and it will displace a very small amount of air, but it is not enough to make a difference in preserving food. Especially as the size of the container increases and the volume of food inside decreases.

Therefore, a need exists for an article of manufacture for providing a resizable food storage container. The present invention attempts to address the limitations and deficiencies in prior solutions according to the principles and example embodiments disclosed herein.

### SUMMARY

In accordance with the present invention, the above and other problems are solved by providing an article of manufacture for a resizable food storage container according to the principles and example embodiments disclosed herein.

In one embodiment, the present invention is an article of manufacture for providing a resizable food storage container. The resizable food storage container includes a container surface wall, a removable lid, and a movable bottom element configured to change a position within the container surface wall changing the storage volume depending upon the position of the movable bottom element within the container surface wall.

In another aspect of the present disclosure, the movable bottom element has an inner bottom surface, an outer bottom surface, and a gasket material coupled to a sealing surface between the inner bottom surface and the outer bottom surface, the gasket material extends outward from the inner bottom surface to fill any gap to the container surface wall.

In yet another aspect of the present disclosure, the resizable storage container may be made of plastic, low-density polyethylene (LPDE), polypropylene (PP), polyethylene (PE), liquid crystal polymer (LCP), polyether sulfone (PES), rubber, glass, and waxed paper and cardboard, and similar food container materials.

In yet another aspect of the present disclosure, the gasket material being configured to slightly deformed when an external force is applied to the outer bottom surface of the bottom element causing the bottom element to move upward within the container surface wall.

In yet another aspect of the present disclosure, the gasket material returns to its original shape creating a seal between the inner bottom surface and the container surface wall when the external force is removed.

In yet another aspect of the present disclosure, the gasket material being configured to slightly deformed when an external force is applied to the inner bottom surface of the bottom element causing the bottom element to move downward within the container surface wall.

In yet another aspect of the present disclosure, the container surface walls are round creating a cylindrical shape.

In yet another aspect of the present disclosure, the container surface walls are square creating a cubic shape.

In yet another aspect of the present disclosure, the container surface walls are rectangular creating a 3D rectangular shape.

The foregoing has outlined rather broadly the features and technical advantages of the present invention in order that the detailed description of the invention that follows may be better understood. Additional features and advantages of the invention will be described hereinafter that form the subject of the claims of the invention.

It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

Referring now to the drawings in which like reference numbers represent corresponding parts throughout:

FIGS. 1a-b illustrate an example embodiment of an article of manufacture for providing a resizable food storage container according to the present invention.

FIGS. 2a-b illustrate another example embodiment of an article of manufacture for providing a resizable food storage container according to the present invention.

FIGS. 3a-b illustrate top and side views of a bottom element used in an article of manufacture for providing a resizable food storage container according to the present invention.

FIG. 4 illustrates yet another example embodiment of an article of manufacture for providing a resizable food storage container according to the present invention.

### DETAILED DESCRIPTION

This application relates to an article of manufacture for providing food storage, and more specifically, to an article of manufacture for providing a resizable food storage container in different configurations according to the present invention.

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

In describing embodiments of the present invention, the following terminology will be used. The singular forms “a,” “an,” and “the” include plural referents unless the context clearly dictates otherwise. As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. As used herein, the singular forms “a,” “an,” and “the” are intended to include the plural forms as well, unless the context clearly indicates otherwise.

It further will be understood that the terms “comprises,” “comprising,” “includes,” and “including” specify the presence of stated features, steps or components, but do not preclude the presence or addition of one or more other features, steps or components. It also should be noted that in some alternative implementations, the functions and acts noted may occur out of the order noted in the figures. For example, two figures shown in succession may in fact be executed substantially concurrently or may sometimes be executed in the reverse order, depending upon the functionality and acts involved.

The terms “food worker” and “user” refer to an entity, e.g., a human, using a resizable food storage container associated with the invention. The term user herein refers to one or more users.

The term “invention” or “present invention” refers to the invention being applied for via the patent application with the title “Food Storage Container.” Invention may be used interchangeably with container.

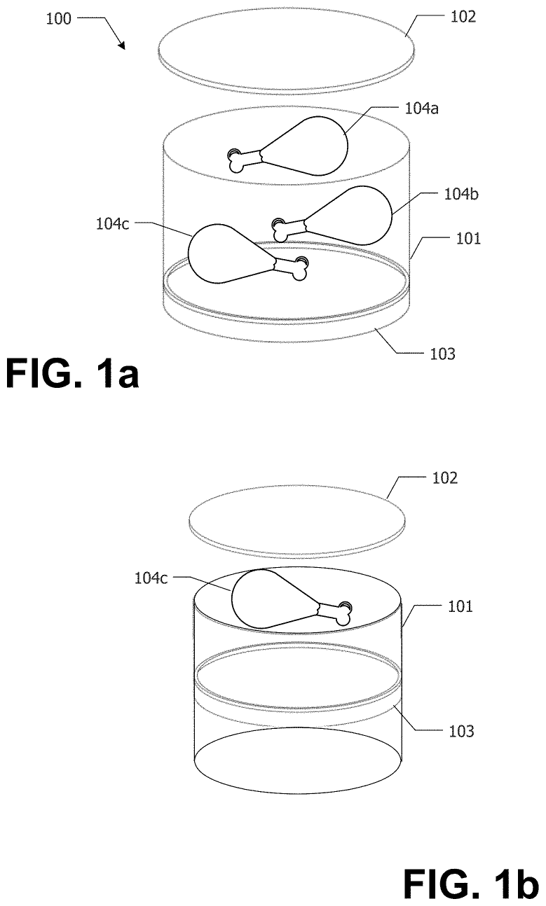

In general, the present disclosure relates to an article of manufacture for providing food storage. To better understand the present invention, FIGS. 1a-b illustrate an example embodiment of an article of manufacture for providing a resizable food storage container 100 according to the present invention. FIGS. 1a-b show two configurations of a food storage container 100 having removable lids 102. A resizable food storage container 100 is sized to accept multiple items of food 104a-c that require a large amount of storage volume. The container 100 also may be sized to hold less food 104c than the first configuration of c resizable food storage container 100 shown in FIG. 1a, thus requiring less storage volume. Each configuration of the resizable food storage containers 100 are sized to minimize the volume of air required within the containers when food is stored therein. Each configuration of the resizable food storage containers 100 include a container surface wall 101, a removable lid 102, and a movable bottom element 103. Elimination of excess air is expected to keep food items fresh for longer periods of time thereby eliminating waste. Currently, these two configurations of the resizable food storage containers 100 require two separate items rather than having a single container 100 that adjusts its volume accordingly.

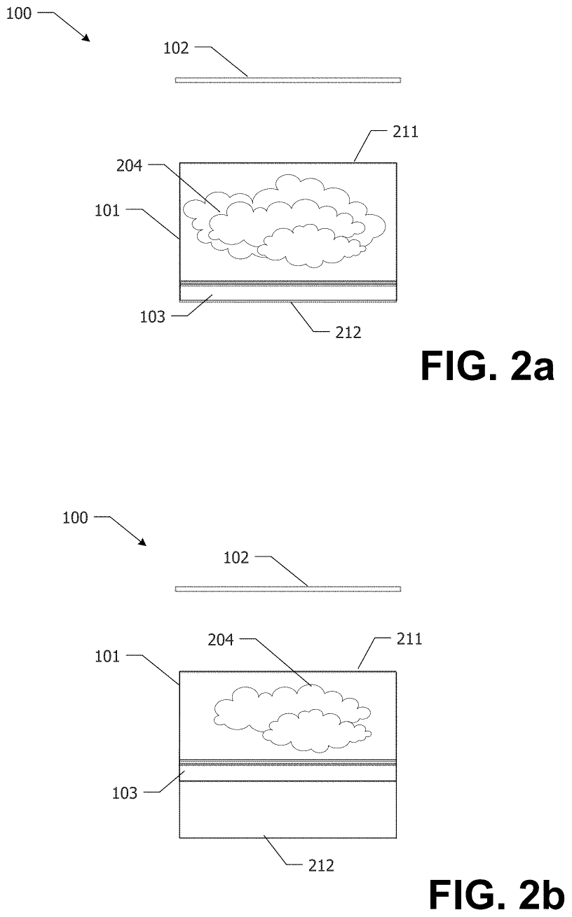

FIGS. 2a-b illustrate another example embodiment of an article of manufacture for providing a resizable food storage container according to the present invention. FIG. 2a shows a side view of the resizable food storage container 100 having the container surface wall 101 and matching lid 102 that also contains a movable bottom element 103 that may be positioned within the container surface wall 101. The movable bottom element 103 may be moved upward and downward within the inside volume of the container surface wall 101 to adjust an amount of available volume between the movable bottom element 103 and the lid 102 when the lid is attached to the container surface wall 101. The lid 102 may be completely removable with edges that engage top surfaces of the container surface wall 101.

A food worker wanting to remove a portion of the contents of the container 100 may remove the lid 102, remove the food material 204, and push the movable bottom element 103 upward to reduce the available volume in the container surface wall 101, as shown if FIG. 2b, before replacing the lid 102. The food storage container 100 is made with the container surface wall 101, a removable lid 102, and movable bottom element 103 and may be made of plastic, low-density polyethylene (LPDE), polypropylene (PP), polyethylene (PE), liquid crystal polymer (LCP), polyether sulfone (PES), rubber, glass, and waxed paper and cardboard, and similar food container materials that adjust to the volume of food material 204 placed inside the container 100.

The bottom element 103 of the food container 100 adjusts, or is pushed upward, toward the top 211 of the container surface wall 101 by pushing up from the bottom 212 of container surface wall 101 on the bottom element 103 with the user's fingers. When a user wishes to add additional food material 204 into the container 100, the user may push the bottom element 103 through the open top 211 of the container surface wall 101 downward. By moving the bottom element 103 upward or downward as needed, the food worker always keeps the container 100 full as the food material 204 is always taking up the entire volume of the available space in the resizable food storage container 100.

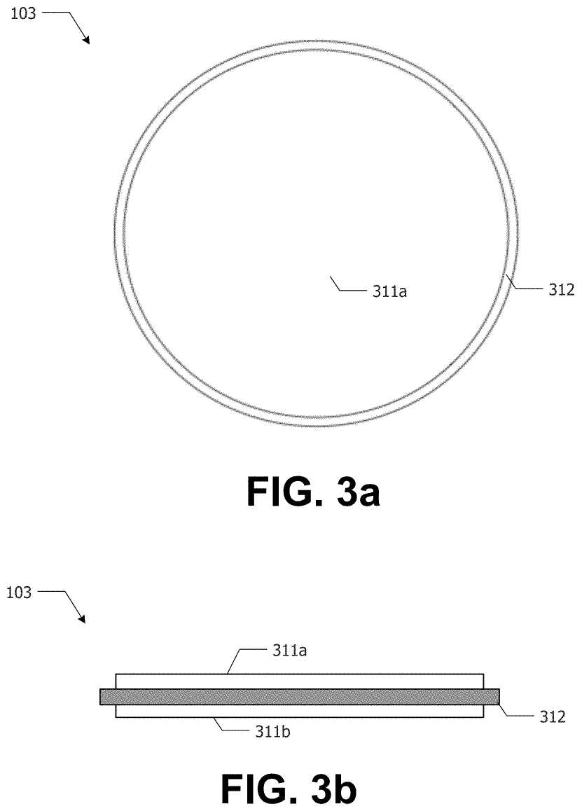

FIGS. 3a-b illustrate top and side views of a bottom element used in an article of manufacture for providing a resizable food storage container according to the present invention. In order for the resizable food storage container 100 to function as disclosed herein, the bottom element 103 must create a sealed edge between outer edges of the bottom element 103 and inside surfaces of the container surface wall 101. The bottom element 103 must provide an airtight seal to prevent food material 204 from leaking from the container surface wall 101 and to prevent outside air from leaking into the container 100. The seal must also permit the bottom element 103 and the seal to remain airtight after the bottom element 103 is moved from one position to another.

The bottom element 103 of FIG. 3b is shown having an inner bottom surface 311a and an outer bottom surface 311b and a sealing gasket 312 around the edges of the bottom element 103. The inner bottom surface 311a is a single flat surface that is typically made of the same material used to construct the container surface wall 101 and the lid 102. The inner bottom surface 311a is sized to be about the size of the inner dimensions of the container surface wall 101. The inner bottom surface 311b is slightly smaller than the inner dimensions of the container surface wall 101 to allow it to move within the container 100. The sealing gasket 312 fills any space between the container surface wall 101 of the container 100 and the bottom element 103 when the bottom element 103 is placed therein.

The gasket material 312 may be made of a flexible material such as rubber, silicone, and similar synthetic materials such that the gasket material 312 may be compressed or deformed slightly when the bottom element 103 is moved and will return to its original shape once the bottom element 103 has been repositioned. The gasket material is coupled to a sealing surface between the inner bottom surface and the outer bottom surface. The gasket material 312 is slightly deformed when force is applied to a bottom side 311b of the bottom element 103, typically about the center of the inner bottom surface 311b, causing it to move as the gasket material 312 remains in contact with the container surface wall 101. The gasket material 312 is moved along with the inner bottom surface 311a until the force moving them both is removed. Once the force is gone, the gasket material 312 may return to its original shape creating a seal between the inner bottom surface 311a and the container surface wall 101. The gasket material 312 may be made of a pliable material comprising soft rubber, polysilicon material, and related synthetic sealing materials.

Both the top view of FIG. 3a and the side view of FIG. 3b of the bottom element 103 are example embodiments for a round resizable food storage container 100. Other shaped and sizes of container 100 may be used as desired. For any alternate shape, the gasket 312 must match the shape to create an air and a water-tight seal between the bottom element 103 and the container surface wall 101, especially about angled surface changes such as corners in the container surface wall 101.

The size of the inner bottom surface 311a and the gasket material 312 are not shown sized to scale relative to each other. The gasket material 312 is shown to emphasize that is extends outward from the inner bottom surface 311a to fill any gap to the container surface wall 101. The inner bottom surface 311a is shown having identical surfaces when compared the top side 311a to the outer bottom side 311b of the bottom element 103. The inner bottom surface 311a is oriented within the container surface wall 101 on the portion of the container receiving food material 204 that is covered by the lid 102. The outer bottom side 311b of the bottom element 103 that the user uses to move the bottom element 103.

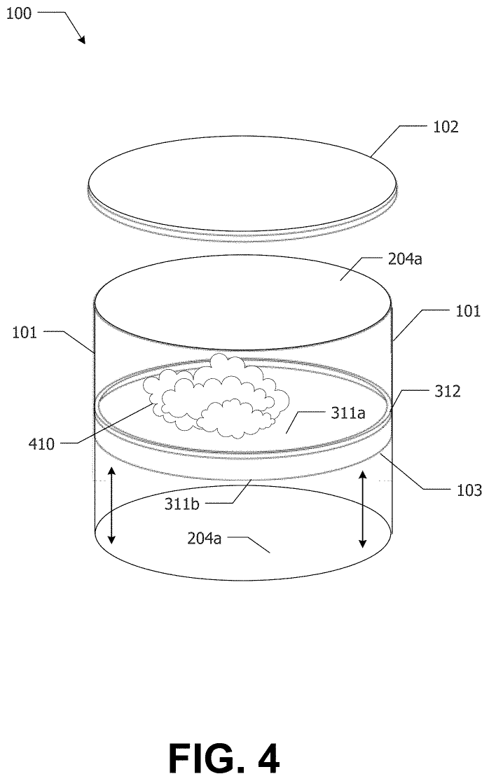

FIG. 4 illustrates yet another example embodiment of an article of manufacture for providing a resizable food storage container according to the present invention. The resizable food storage container 100 is shown having a container surface wall 101 and a bottom element 103 within the resizable food storage container 100. Consider an example use of the container 100 in which guacamole 410 is placed in a resizable food storage container 100. If the container 100 is not kept completely full to the lid 102, the guacamole 410 will start to brown on top, the part exposed to the most air. Therefore, if the guacamole 410 is kept consistently toward the top of the container surface wall 101 and the lid 102, even as a portion of the guacamole 410 is removed, the guacamole 410 will spoil less and last longer. The elimination of the excess air will significantly increase the shelf life of all food material 410 that spoils when exposed to air. By eliminating the air space in the resizable food storage container 100.

Even though particular combinations of features are recited in the present application, these combinations are not intended to limit the disclosure of the invention. In fact, many of these features may be combined in ways not specifically recited in this application. In other words, any of the features mentioned in this application may be included in this new invention in any combination or combinations to allow the functionality required for the desired operations.

No element, act, or instruction used in the present application should be construed as critical or essential to the invention unless explicitly described as such. Further, the phrase “based on” is intended to mean “based, at least in part, on” unless explicitly stated otherwise.

What is claimed is:

1. An article of manufacture for providing a resizable food storage container in different configurations, the resizable food storage container comprises:
a container surface wall;
a removable lid; and
a movable bottom element configured to change a position within the container surface wall changing the storage volume depending upon the position of the movable bottom element within the container surface wall.

2. The resizable food storage container according to claim 1, wherein the movable bottom element comprises:
an inner bottom surface;
an outer bottom surface; and
a gasket material coupled to a sealing surface between the inner bottom surface and the outer bottom surface, the gasket material extends outward from the inner bottom surface to fill any gap to the container surface wall.

3. The resizable food storage container according to claim 2, wherein the gasket material being configured to slightly deformed when an external force is applied to the outer bottom surface of the bottom element causing the bottom element to move upward within the container surface wall.

4. The resizable food storage container according to claim 3, wherein the gasket material returns to its original shape creating a seal between the inner bottom surface and the container surface wall when the external force is removed.

5. The resizable food storage container according to claim 2, wherein the gasket material being configured to slightly deformed when an external force is applied to the inner bottom surface of the bottom element causing the bottom element to move downward within the container surface wall.

6. The resizable food storage container according to claim 5, wherein the gasket material returns to its original shape creating a seal between the inner bottom surface and the container surface wall when the external force is removed.

7. The resizable food storage container according to claim 2, wherein the gasket material is made of a material comprising one of the following: soft rubber, polysilicon material, and synthetic sealing materials.

8. The resizable food storage container according to claim 2, wherein the container surface walls are round creating a cylindrical shape.

9. The resizable food storage container according to claim 2, wherein the container surface walls are square creating a cubic shape.

10. The resizable food storage container according to claim 2, wherein the container surface walls are rectangular creating a 3D rectangular shape.

11. The resizable food storage container according to claim 2, wherein the container surface walls are made from a container material comprising one or more of the following: plastic, rubber, glass, and waxed paper and cardboard.

12. The resizable food storage container according to claim 2, wherein the container material further comprises low-density polyethylene (LPDE), polypropylene (PP), polyethylene (PE), liquid crystal polymer (LCP), polyether sulfone (PES),
